(19) United States
(12) Patent Application Publication
(10) Pub. No.: US 2014/0025533 A1
(43) Pub. Date: Jan. 23, 2014

(54) Method and Apparatus of Recommending Clothing Products

(71) Applicant: Alibaba Group Holding Limited, Grand Cayman (KY)

(72) Inventor: Hao Lv, Hangzhou (CN)

(73) Assignee: Alibaba Group Holding Limited, Grand Cayman (KY)

(21) Appl. No.: 13/944,785

(22) Filed: Jul. 17, 2013

(30) Foreign Application Priority Data
Jul. 20, 2012 (CN) 201210254720.1

(51) Int. Cl. G06Q 30/06

(52) U.S. Cl. CPC G06Q 30/0631
USPC 705/26.7

(57) ABSTRACT

The present disclosure provides techniques to recommending items (clothing items). These techniques may send an item operation request including a user identifier. After receiving the request, the server may determine a pre-established correspondence between the user identifier and attribute values of the items' first attribute based on the user identifier. The server may acquire the attribute values corresponding to the user identifier contained in the request. The server may then select certain items from the items associated with the corresponding attribute values, and recommend the certain items to users. These techniques avoid problems of existing technologies and improve item recommendation efficiency.

### CROSS REFERENCE TO RELATED PATENT APPLICATIONS

This application claims priority to Chinese Patent Application No. 201210254720.1, filed on Jul. 20, 2012, entitled “Method and Apparatus of Recommending Clothing Products,” which is hereby incorporated by reference in its entirety.

### TECHNICAL FIELD

The present disclosure relates to information processing technologies and, more specifically to recommending items.

### BACKGROUND

With the rapid development of Internet technologies, more and more services may be carried out via the Internet. For example, through Internet communications terminals, a user may access a website's services. In general, a service provider uses servers to publish business objects and to process business information provided by the terminals.

Generally, the server may divide a business into various categories based on types of services provided to the user. In addition, the server may display the business categories and business objects in each category to the terminal user. Thus, the terminal user may use a user identifier (ID) or a name of each category to select a corresponding category and to identify desired business objects from the corresponding category. In this instance, the server uses the terminal to conduct category guidance, recommends business objects to the terminal, and causes a display to the terminal user. In addition, the server may also search for categories or business objects corresponding to keywords provided by the terminal user, and return search results.

Through a service provided by a server, a website may provide clothing products, electronic products, and various accessories selected by a terminal user. The clothing products may be a single article of clothing or a set of clothing, such as a shirt, a pair of shorts, or a set of formal attire. Accordingly, categories to which the different clothing products belong are determined by the server based on characteristics of the clothing products. The categories may be referred to as clothing categories. These clothing categories may be multi-level categories. A first-order category is set as the category to which all of the clothing products offered by the website belong. Taking it further, this first-order category includes multiple subcategories. For example, the category may include two subcategories: women's clothing and men's clothing. These subcategories of women's and men's clothing may be further divided into more subcategories. For example, the women's clothing subcategory may continue to be divided to include other subcategories such as one subcategory for skirts, and the men's clothing subcategory may continue to be divided to include other subcategories such as one subcategory for pants. The clothing products include at least one skirt for the skirt subcategory and at least one pair of pants from the pants subcategory.

When the server makes recommendations to the terminal for the abovementioned clothing products, it may use the clothing products' clothing categories to guide the terminal user to select a certain clothing product. Alternatively, given keywords submitted by the terminal such as “maxi skirt”, the server may search for clothing products or clothing categories matching the keywords. If a matched object is the subcategory “skirts”, the server may recommend clothing products or other products in this subcategory.

However, under conventional technologies, every time a terminal user browses the website, the server needs to instruct the terminal in the category guidance and to guide the terminal user in a step-by-step selection of the clothing category containing the clothing product that the terminal user desires purchase. The terminal user may select a clothing product from this clothing category that conforms to the terminal user's clothing style. Here, the clothing style may be a clothing product attribute based on the characteristics of an object such as a user or an occasion to which the clothing product is suited. For example, a clothing style with the clothing characteristics of the Euro-American region may be defined as a Euro-American style, and a clothing style with the clothing characteristics of a designated ethnicity may be defined as an ethnic style. There are a variety of ways to define clothing styles. Using categories to guide clothing product recommendations, the server may take quite a bit of time to identify a clothing category and clothing products prior to determining the desired clothing product, thus resulting in low efficiency for clothing product recommendations.

The server may recommend clothing products to the terminal based on terminal-submitted keywords. However, the recommendation is primarily based on keywords submitted by the terminal user. If the keywords are not consistent with the terminal user's intent, or the keywords are not commonly used, the server may return irrelevant search results. This also decreases the efficiency of the server's clothing product recommendations.

In sum, the current technologies for clothing product recommendation have relatively low efficiency.

### SUMMARY

Embodiments of the present disclosure relates to methods and devices for recommending items (e.g., clothing products), and solves the problem of low efficiency of the current technologies in item recommendations.

In some embodiments, a server receives a clothing product operation request including a user identifier (ID) sent by a terminal. Based on the user identifier, the server may query a pre-established correspondence between the user ID and attribute features of the clothing products' first attribute. Then, the server may acquire the attribute features corresponding to the user identifier contained in the request. The corresponding attribute features are the attribute features that the user corresponding to the user identifier is interested in. Clothing products may be selected from the clothing products corresponding attribute features, and then are recommended to the terminal.

In some embodiments, a device for recommending clothing products may include a request reception unit configured to receive a clothing product operation request including a user identifier sent by a terminal. The device may also include an attribute feature acquisition unit configured to query a pre-established correspondence between the user ID and attribute features of the clothing products' first attribute based on the user ID included in the request received by the request reception unit. The attribute feature acquisition unit may acquire the attribute features corresponding to the user identifier included in the operation request. The corresponding attribute features are the attribute features that the user corresponding to the user identifier of the operation request is interested in. The device may also include a clothing product recommendation unit configured to select clothing products from the clothing products associated with the attribute features acquired by the attribute feature acquisition unit, and then to recommend the clothing products to the terminal.

In some embodiments, after the server receives a clothing product operation request including a user ID sent by a terminal, the server may query a pre-established correspondence between the user identifier and attribute features of the clothing products' first attribute to acquire the attribute features corresponding to the user ID contained in the request. The acquired attribute features are the attribute features that the user corresponding to the user ID is interested in. In addition, clothing products may be selected from the clothing products corresponding attribute features, and then may be recommended to the terminal. Accordingly, it is possible to establish a correspondence between the user identifier and the attribute features of the clothing products' first attribute in advance. These attribute features are the attribute features that the user corresponding to the user ID is interested in. Therefore, the server may directly select clothing products from the clothing products associated with the acquired attribute features based on the user ID of the clothing product operation request submitted by the terminal. The server may select the clothing products after acquiring the saved attribute features corresponding to the user ID. This avoids the problem of existing technologies, which has low efficiency in clothing product recommendations. In addition, the selected clothing products are clothing products associated with the attribute features that the user is interested in. This avoids the problem with existing technologies of inaccurate keywords, and improves clothing recommendation efficiency.

Other features and advantages of this disclosure will be detailed in the Description below and will be partially evident from the Description or understood through the implementation of this disclosure. The goals and other advantages of this disclosure may be implemented and obtained through the structures specifically indicated in the Description, Claims, and attached figures.

This Summary is not intended to identify all key features or essential features of the claimed subject matter, nor is it intended to be used alone as an aid in determining the scope of the claimed subject matter.

### BRIEF DESCRIPTION OF THE DRAWINGS

The Detailed Description is described with reference to the accompanying figures. The use of the same reference numbers in different figures indicates similar or identical items.

FIG. 1 is schematic diagram of a template associated with item information.

FIG. 2 is a flow chart of an illustrative process for item recommendation.

FIG. 3 is a schematic diagram of exemplary item categories.

FIG. 4 is a flow chart of an illustrative process for establishing a correspondence between a user ID and the attribute features of the items' first attribute.

FIG. 5 is a flow chart of another illustrative process for establishing a correspondence between a user ID and the attribute features of the items' first attribute.

FIG. 6 is a flow chart for an illustrative process for selecting clothing products.

FIG. 7 is a schematic diagram of illustrative computing architectures that enable recommendation of items.

### DETAILED DESCRIPTION

Embodiments of this disclosure provide methods and devices for recommending items (e.g., clothing products) to improve the efficiency of item recommendations. Together with the attached figures, the following description explains the embodiments of this disclosure. To be clear, the embodiments described here are simply for the purpose of describing and explaining this disclosure and are not used to limit this disclosure. In addition, at least two embodiments of this disclosure and the characteristics of the embodiments may be combined with each other.

In some embodiments, the server may provide business objects other than clothing products, such as electronic products. Some embodiments of this disclosure use clothing products as an example. In some embodiments, the server may use methods provided by this disclosure for recommending clothing products to recommend other business objects.

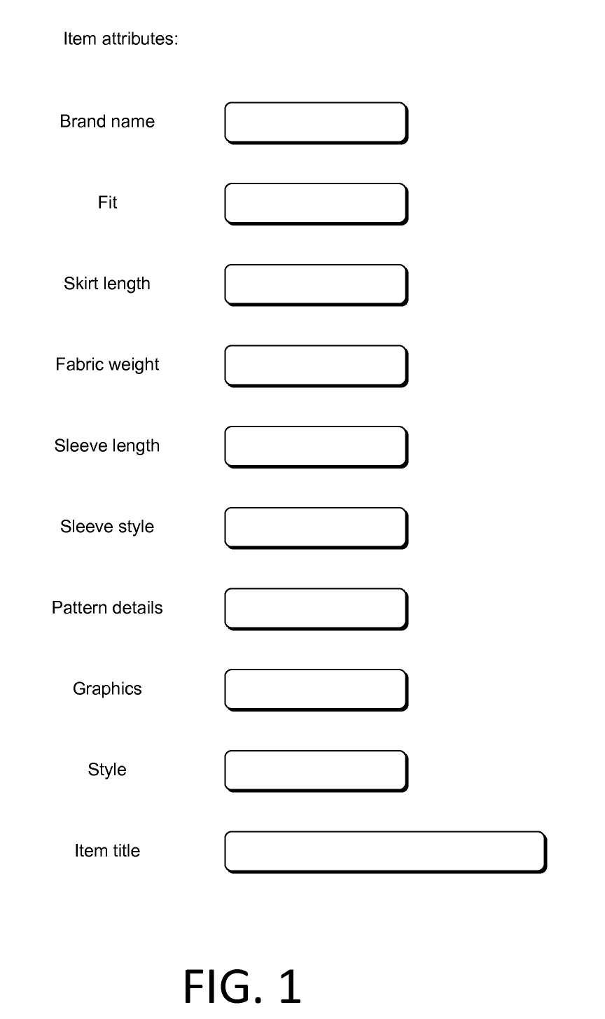

FIG. 1 is schematic diagram of a template associated with item information. In some embodiments, a server may upload clothing product information to clothing product provision units associated with the server. In these instances, the server may instruct a clothing provision unit to provide clothing product information according to a designated mode. For example, as illustrated in FIG. 1, a template may be used for providing clothing product information. In this template, clothing product information may be defined as item attributes, wherein brand name, fit, skirt length, fabric weight, sleeve length, sleeve style, pattern details, graphics, and style are all clothing product attributes. In a dialog box corresponding to each attribute, the content filled in or selected is the attribute feature for different attributes. The attribute feature may include specific details of each clothing product attribute. For example, a brand name is “A”, and the style is “street”. As results, “A” is the brand name of the clothing product, and “street” is the style of the clothing product. In some embodiments, clothing products might have more than one attributes. In some instances, an attributes of the clothing products is style, and is referred as the first attribute.

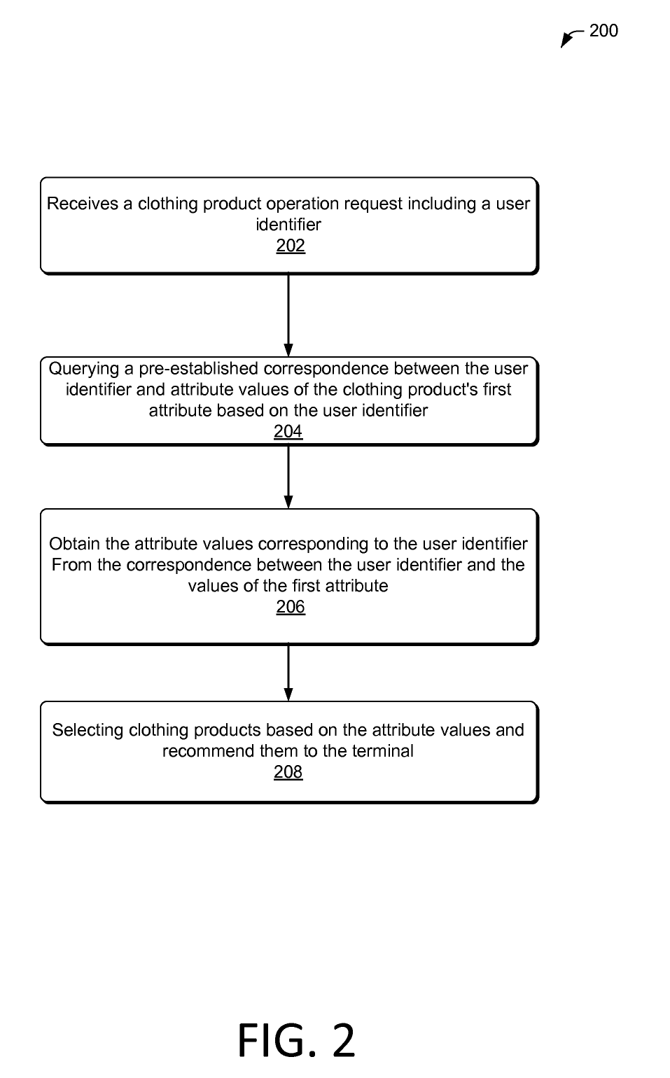

FIG. 2 is a flow chart of an illustrative process for item recommendation. The process may be implemented by servers that provide clothing products as well as other business objects. At 202, the server receives a clothing product operation request including a user ID sent by a terminal.

In some embodiments, the user ID is used to indicate the user who triggered the terminal to send the clothing product operation request, when conducting a designated operation on a designated website. In some embodiments, the user ID may be account information from the terminal user's successful registration with a server for a designated website. In some instances, the user ID may be a terminal ID. For example, when the terminal user navigates to a webpage of the designated website and does not use registered account information to log onto the designated website, or when there is no registered account information, the terminal may use the terminal ID as the user ID. The terminal may include the terminal ID in the clothing product operation request, and send it to the server after the terminal user navigates to a page of the designated website.

At 204, the server searches and/or queries a pre-established correspondence between the user ID and attribute features of the clothing products' first attribute based on the user ID.

In some embodiments, the first attribute of the clothing product is the product's style, and the attribute feature is used to reflect the style of the clothing. The attribute features corresponding to the user ID are the attribute features that the user corresponding to the user ID is interested in. In other words, the attribute feature may be a particular style of clothing the user likes.

In some embodiments, there may be multiple clothing product attributes, such as brand name and style. Individual attribute may have multiple corresponding attribute features, and the individual attribute for a piece of clothing has its own corresponding attribute feature. In some instances, clothing style may be a major factor in the terminal user's selection of a clothing product, and may be used as the basis for recommending clothing products. Thus, embodiments of this disclosure user use of style as a clothing product attribute, and may conserve server resources. In contrast, existing technologies primarily define clothing product attributes based on characteristics such as the clothing product's brand name and pattern. For example, a pattern of clothing may change with the seasons; so the server needs to update the data reflecting the pattern of the clothing products in light of the seasons. This takes up the server's resources. In contrast, the style of clothing products does not require updating due to the change of seasons; so the server does not need to update the data reflecting the style of the clothing products due to the change of seasons, thus conserving the server's resources.

At 206, the server obtains the attribute features corresponding to the user ID contained in the clothing product operation request from the correspondence between the user ID and the features of the first attribute.

At 208, the server selects clothing products from the clothing products possessing the acquired attribute features and recommends them to the terminal.

In some embodiments, the server may establish in advance a correspondence between the user ID and the features of the first attribute of the clothing products. These attribute features are the attribute features that the user corresponding to the user ID is interested in. Therefore, based on the user ID of the clothing product operation request submitted by the terminal, the server may directly select clothing products from the clothing products associated with the acquired attribute features after acquiring the saved attribute features corresponding to the user ID. This avoids the problem of existing technologies in which it takes a long time to recommend clothing products to the terminal, leading to low efficiency in clothing product recommendations. In addition, the selected clothing products are clothing products associated with the attribute features that the user is interested in. This avoids the problem with existing technologies of inaccurate keywords leading to low efficiency in clothing recommendations, and also improves clothing recommendation efficiency.

In some embodiments, a server may select clothing products from the clothing products associated with the acquired attribute features, and recommend them to the terminal. When the server selects the clothing products, the server may set a category of clothing associated with the acquired attribute features, and then select clothing products associated with the acquired attribute features from the set clothing category.

In some embodiments, a clothing category will have the attributes of each of its clothing products, and it will have the attribute features of each of its clothing products. For example, there is a clothing category with three clothing products. There is an attribute feature for the first attribute of each of these three clothing products, and these three attribute features are different. So the clothing category is associated with the first attribute, and also associated with three attribute features corresponding to this first attribute.

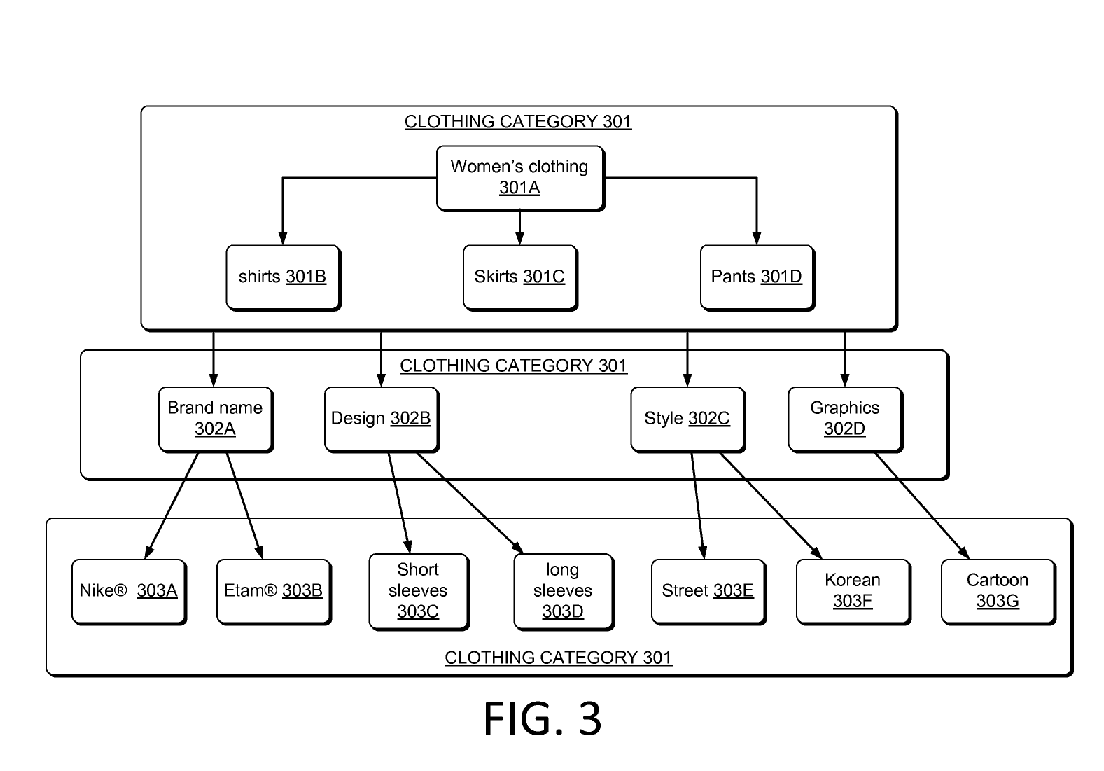

FIG. 3 is a schematic diagram of exemplary item categories. In some embodiments, a clothing category 301 includes the first-order category of women's clothing 301A. The clothing products included in this first-order category may be further broken down into categories for shirts 301B, skirts 301C, and pants 301D. In some embodiments, there may be multiple subcategories; the subcategories of shirts 301B, skirts 301C, and pants 301D are used as an illustration. The attributes of the first-order category include the attributes possessed by each subcategory. For example, brand name 302A, pattern 302B, style 302C, and graphics 302D in category attributes 302 are the attributes associated with the subcategories of the first-order category; so this first-order category may also include these attributes. It is possible that different clothing products of the first-order category women's clothing 301A may have their own attribute features for the same attribute; so the first-order category women's clothing 301A will have the attribute features associated with each of its clothing products. Therefore, the different attributes of category attributes 302 may correspond to multiple attribute features.

As shown in category attribute features 303, the attribute features corresponding to brand name 302A are Nike® 303A and Etam® 303B, the attribute features corresponding to pattern 302B are short sleeves 303C and long sleeves 303D, the attribute features corresponding to style 302C are street 303E and Korean 303F, and the attribute feature corresponding to graphics 302D is cartoon 303G. In some embodiments, each attribute of the category attributes 302 and each attribute feature of the category attribute features 303 may be expressed as a binary number of a set number of digits. There is a correspondence between the digits used to reflect an attribute and the digits reflecting the corresponding attribute feature. In some embodiments, this correspondence may be referred to as a correspondence between each of the abovementioned attributes of the category attributes 302 and the attribute features of the category attributes features 303.

In some embodiments, the pre-established correspondence between the user ID and attribute features of the clothing products' first attribute may be identified and/or queried based on the user ID. A mode of establishing the correspondence between the user ID and the attribute features of the clothing products' first attribute may be flexibly handled based on the actual situation. This disclosure provides a number of specific embodiments for establishing a correspondence between the user ID and the attribute features of the clothing products' first attribute.

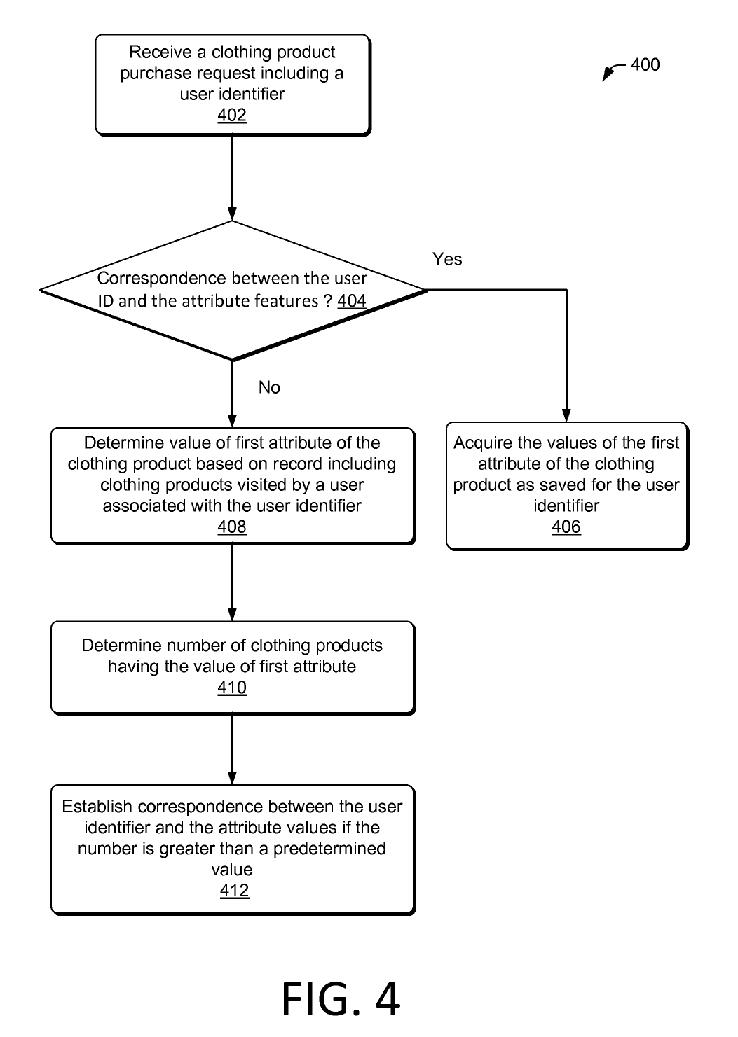

FIG. 4 is a flow chart of an illustrative process for establishing a correspondence between a user ID and the attribute features of the items' first attribute. In some embodiments, the server may set up a correspondence between the user ID and the attribute features of the clothing products' first attribute based on the record of accessed clothing products saved for the user ID.

At 402, the server receives a clothing product acquisition request, including a user ID. At 404, the server determines whether or not a correspondence between the user ID and the attribute features of the first attribute of the clothing product exists, based on the user ID.

If the correspondence exits, the process 400 goes to operation 406. At 406, the server acquires the attribute features of the first attribute of the clothing product as saved for the user ID.

If the correspondence does not exist, the process 400 goes to operation 408. At 408, the server determines the attribute features of the first attribute of the clothing products accessed from the record of accessed clothing products saved for the user ID.

In some embodiments, the record of accessed clothing products saved for the user ID may be acquired from local information saved for the user ID. Alternatively, the terminal may be instructed to acquire local terminal information saved for the user ID. The record of accessed clothing products may be acquired from the information returned by the terminal, or the record of accessed clothing products saved for the user ID may be acquired directly from the terminal.

At 410, the server determines a number of clothing products with the same attribute feature from the accessed clothing products with regard to a given one of the determined attribute features. In some embodiments, there may be multiple clothing products corresponding to the same attribute feature among the clothing products saved for a user ID. Thus, it is possible to determine the number of clothing products among the accessed clothing products, possessing a given attribute feature, and to use this as the server's basis for selecting an attribute feature.

At 412, the server may establish a correspondence between the user ID and the attribute features corresponding to those determined numbers that are not less than a first threshold.

In some embodiments, the server may select a number from the determined numbers that is equal to or greater than a first threshold and establish a correspondence between the attribute feature to which the number corresponds and the user ID. Alternatively, the server may directly establish a correspondence between the attribute feature corresponding to the largest number and the user ID. In addition, the first threshold may be set in real time based on the actual values of the determined numbers, or it may be set in advanced based on empirical values. The specific mode for setting the threshold value may be flexibly selected based on the actual situation.

In some embodiments, after the operations 402 and step 404, the server may establish in real time a correspondence between the user ID and the attribute features of the clothing products' first attribute after the server determines that there is no correspondence between the user ID and the attribute features of the clothing products' first attribute. In some embodiments, the server may also establish or update correspondences between user IDs and the attribute features of the clothing products' first attribute based on a set length of time or set trigger conditions.

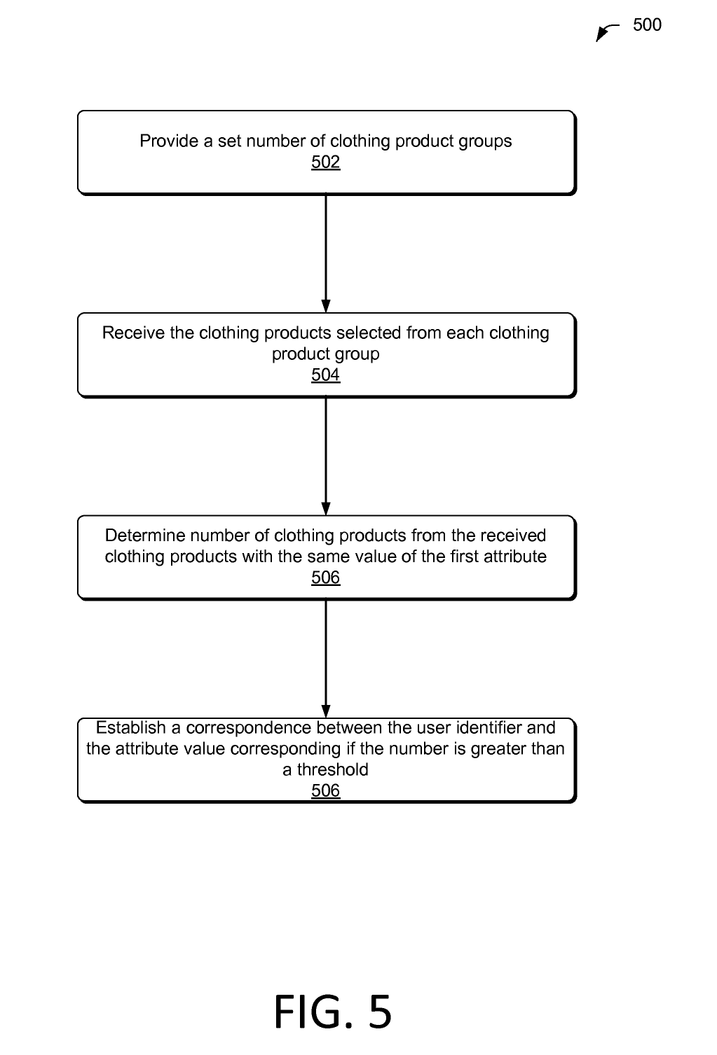

FIG. 5 is a flow chart of another illustrative process for establishing a correspondence between a user ID and the attribute features of the items' first attribute. In some embodiments, the server may establish a correspondence between a user ID and the attribute features of the clothing products' first attribute by inferring the attribute features of the clothing products that the user corresponding to the user ID is interested in.

At 502, the server provides the terminal with a set number of clothing product groups. In some embodiments, the quantity of clothing products included in each of the clothing product groups is the same as the number of attribute features for the first attribute. The attribute features the first attribute for the included clothing products may be all different. For example, clothing products with a first attribute of “style”. A clothing product website provides 8 styles (e.g., 8 different attribute features); so each clothing product group provided by the server to the terminal includes 8 clothing products, and each of the 8 clothing products corresponds to one of the styles. The 5 clothing product groups are shown in Table 1.

TABLE 1

| Style | Style | Style | Style | Style | Style | Style | Style |
|---|---|---|---|---|---|---|---|
| A | B | C | D | E | F | G | H |
| A1 | B1 | C1 | D1 | E1 | F1 | G1 | H1 |
| A2 | B2 | C2 | D2 | E2 | F2 | G2 | H2 |
| A3 | B3 | C3 | D3 | E3 | F3 | G3 | H3 |
| A4 | B4 | C4 | D4 | E4 | F4 | G4 | H4 |
| A5 | B5 | C5 | D5 | E5 | F5 | G5 | H5 |

As illustrated in the table 1, the server provides the terminal with five clothing product groups each clothing product group includes eight clothing products. The styles are Style A, Style B, Style C, Style D, Style E, Style F, Style G, and Style H. The terminal user may select a designated number of clothing products for all of these clothing product groups, or any number of clothing products for each separate clothing product group.

At 504, the server receives the clothing products selected by the terminal from each clothing product group. In some embodiments, the clothing products received by the server are the clothing products selected from each clothing product group by the terminal based on the table of clothing product groups. For example, the terminal user may use the terminal to select any one of the clothing product groups. In addition, the user may select the next group or another group after a designated number of clothing products are chosen from the group. The terminal may provide the user with another clothing product group and instructs the user to choose a designated number of clothing products. This operation may continue until a designated number of clothing products are chosen from the five clothing product groups. In some embodiments, the server may also provide the terminal with more clothing product groups. The number of clothing products included in each clothing product group may be determined according to the number of attribute features for the first attribute.

At 506, the server may determine the number of clothing products from the received clothing products with the same attribute feature for the first attribute.

At 508, the server establishes a correspondence between the user ID and the attribute features corresponding to those determined numbers that are not less than a second threshold. In some embodiments, the determined number may be equal to or greater than a second threshold number, or it may be the highest value. In some instances, conditions for selecting a number from the determined numbers may be based on requirements for the number of determined attribute features, or they may be based on clothing product recommendation requirements. The determined attribute features may be expressed using binary numbers. For example, the determined attribute feature is for “style”. The style types include “Korean” and “street”. Therefore, these two style attributes may be indicated in a designated position of a binary value of a set number of digits. For example, in 0000101, the first 1 on the right is used to indicate that the style is “street,” and the second 1 is used to indicate that the style is “Korean.” In some embodiments, it is also possible to indicate the type of style in other ways based on the actual situation.

Embodiments for establishing a correspondence between a user ID and an attribute feature of the first attribute of clothing products may be combined in an implementation scheme for establishing a correspondence between a user ID and attribute features of the first attribute of clothing products. For example, at the operation 408, if there is no record of accessed clothing products saved for the user ID, the server may choose to execute the scheme of the process 500 for establishing a correspondence. In some embodiments, it is also possible to flexibly set up ways of establishing a correspondence between a user ID and attribute features of the first attribute of clothing products based on the actual situation.

In some embodiments, the server may select clothing products from the clothing products possessing the acquired attribute features and recommend them to the terminal in various manners.

In some embodiments, the server may select clothing products associated with a designated value or feature for the second attribute from among the clothing products possessing the acquired attribute feature for the first attribute. The server may select clothing products from the selected products associated with the designated second attribute feature. In some instances, the designated second attribute feature may be another attribute feature aside from the attribute feature of the first attribute. The second attribute feature may have been previously saved for the user ID. Alternatively, the second attribute feature may be an attribute feature meeting certain conditions, and may be determined in real time based on the attribute features of the clothing products possessing the attribute features of the first attribute. For example, an attribute other than a first attribute and that meets recommendation conditions is selected from the attributes of the clothing products associated with the acquired attribute features, and the selected attribute serves is then designed as the second attribute. An attribute feature meeting recommendation conditions is selected from the attribute features of the second attribute associated with the clothing products, and may be the designated attribute feature. Alternatively, an attribute feature other than the attribute features of the first attribute and meeting recommendation conditions is selected directly from the attribute features possessed by the clothing products associated with the acquired attribute features, and may be the designated second attribute feature.

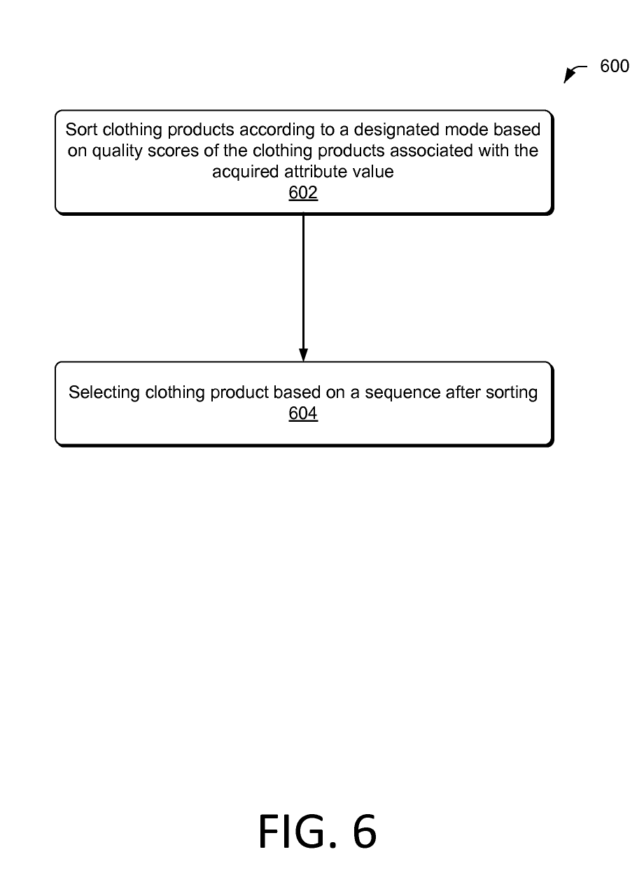

FIG. 6 is a flow chart for an illustrative process for selecting clothing products. In some embodiments, the server may select clothing products from those associated with acquired attribute features based on the quality scores of the clothing products.

At 602, the server sorts the clothing products according to a designated mode based on the quality scores of the clothing products associated with the acquired attribute features.

In some embodiments, the quality score reflects the quality of the clothing product. In some instances, there are a variety of ways to determine the quality scores of clothing products. For example, the quality score for a clothing product may be determined based on the time its information was updated or the frequency or character count of user evaluations of the clothing product. In some instances, the quality score for a clothing product may be determined based on the number of times it was shared or recommended by terminal users. In some instances, the quality score for a clothing product may be determined based on the number of times it was forwarded on information exchange platforms. In some instances, a variety of ways to determine the quality score for a clothing product may be integrated in determining a final quality score in order to improve the accuracy of the clothing product's quality score.

At 604, the server may select a clothing product based on the position of which in the sequence conforms to set position conditions from the sorted clothing product sequence.

In some embodiments, a clothing product may be selected based on the mode of sorting clothing products in a sequence of clothing products. For example, if the clothing products are sorted from large to small based on the size of their scores, the clothing product at the front of the sequence may be selected. The number of clothing products selected may be determined based on the number of recommendations required.

In some embodiments, the server sorts the clothing products according to a designated mode based on the quality scores of the clothing products associated with the acquired attribute features. The quality scores associated with sorting may be determined based on score tables for designated operations received by the server. In some embodiments, the server may measure the scores using a table (e.g., Table 2).

TABLE 2

| | data type | | | Chinese |
|---|---|---|---|---|
| name | (precision range) | Is it empty? | default | meaning |
| id | BIGINT(20) | no | | scoring item |
| | | | | ID |
| type | Varchar(16) | no | | type |
| number | INTEGER | no | | number |
| score | INTEGER | no | | weighted |
| | | | | value |
| type_name | VARCHAR(64) | yes | | description |
| | | | | of type eg: |
| | | | | time of |
| | | | | share |
| number_name | VARCHAR(64) | yes | | description |
| | | | | of number |
| opt_nick | VARCHAR(64) | yes | | reviser nick |
| gmt_create | DATETIME | no | | time |
| | | | | created |
| gmt_modified | DATETIME | no | | time of last |
| | | | | revision |

As illustrated, Table 2 contains a variety of score parameters for assessing clothing products, and each parameter is used to reflect a situation in which the clothing product received a designated operation by the user. For example, “id” indicates the designated operation received by the clothing product, and the corresponding Chinese language meaning is “pingfen xiang” (i.e., scoring item); “type” indicates the type of designated operation. For example, the operation of commenting on the clothing product is designated as type A, and the operation of navigating to the clothing product is designated as type B. The “number” is the number corresponding to different scores; the “score” is a weighted value that reflects the weight given to each score when tallying all of the scores for a clothing product. The other parameters listed in Table 2 are explained in the “Chinese meaning” column and will not be detailed here. In some instances, the “data type” column reflects the data type of the content corresponding to each name, selected or installed in disclosure programs.

In some embodiments, a scoring table is set up for each of the designated operations received by the clothing product. Each scoring table is flexibly set up, using the table set-up mode presented by Table 2 as a basis. The scoring table may be used for scoring the clothing product with regard to each designated operation, as shown in Table 3 and Table 4.

TABLE 3

| comments | | |
|---|---|---|
| character count | number | score |
| 200 and above | A1 | 60 |
| 100-200 | A2 | 40 |
| 10-100 | A3 | 30 |
| 10 and under | A4 | 0 |

As illustrated in Table 3, the “comments character count” is the server's division of comment character counts into grades, after a user makes a comment about a clothing product. The “number” is used to indicate the different grades; and the “score” column gives the corresponding scores for different grades. The more characters there are in a comment, the higher the score is. In real-life disclosures, it is also possible to score clothing products based on the keywords appearing in evaluation content. For example, if the evaluation includes words of approval for the clothing product, the clothing product may be given a rather high score.

TABLE 4

| was it viewed? | number | score |
|---|---|---|
| yes | B1 | 25 |
| no | B2 | 0 |

As illustrated, Table 4 scores clothing products based on whether or not the clothing product was viewed. In some embodiments, it is also possible to score a clothing product based on its number of views, but we will not go through that here.

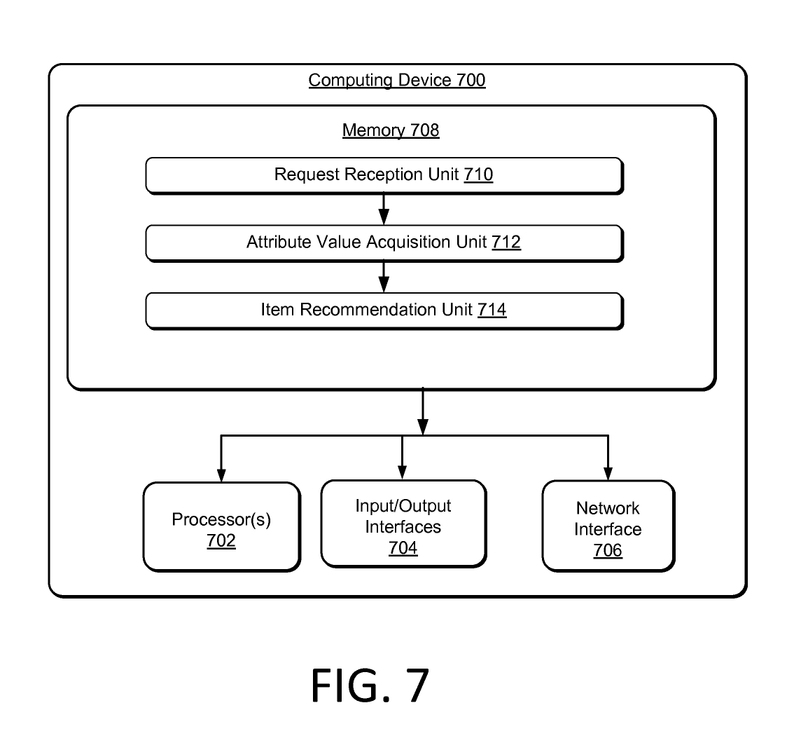

FIG. 7 is a schematic diagram of illustrative computing architectures of a computing device 700 that enable recommendation of items. The computing device 700 may be a user device or a server for a multiple location login control. In one exemplary configuration, the computing device 700 includes one or more processors 702, input/output interfaces 704, network interface 706, and memory 708.

The memory 708 may include computer-readable media in the form of volatile memory, such as random-access memory (RAM) and/or non-volatile memory, such as read only memory (ROM) or flash RAM. The memory 708 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 708 in more detail, the memory 708 may include a request reception unit 710, an attribute feature acquisition unit 712, and an item recommendation unit 714. The request reception unit 710 is configured to receive a clothing product operation request, including a user ID, sent by a terminal. The attribute feature acquisition unit 712 is configured to query the pre-established correspondence between the user ID and attribute features of the clothing products' first attribute based on the user ID included in the request received by the request reception unit 710. The attribute feature acquisition unit 712 may also acquire the attribute features corresponding to the user ID included in the operation request. In some embodiments, the corresponding attribute features are the attribute features that the user corresponding to the user ID of the operation request is interested in.

The item recommendation unit 714 is configured to select clothing products from the clothing products possessing the attribute features acquired by the attribute feature acquisition unit 712, and recommend them to the terminal.

In some embodiments, the attribute feature acquisition unit 712 may determine the attribute features of the first attribute of the accessed clothing products that are taken from the record of accessed clothing products saved for the user ID. The attribute feature acquisition unit 712 may then determine the number of clothing products among the accessed products having the same attribute feature among the determined attribute features. The attribute feature acquisition unit 712 may establish a correspondence between the user ID and the attribute features corresponding to those determined numbers that are not less than a given threshold.

In some embodiments, the attribute feature acquisition unit 712 may provide the terminal with a set number of clothing product groups. The quantity of clothing products in each clothing product group is the same as the number of attribute features of the first attribute, and the attribute features of the first attribute of every clothing product included are different. The attribute feature acquisition unit 712 may receive the selected clothing products from each clothing product group, sent by the terminal, and determine the number of clothing products with the same attribute feature for the first attribute from among the received clothing products. The attribute feature acquisition unit 712 may establish a correspondence between the user ID and the attribute features corresponding to those determined numbers that are not less than a given threshold.

In some embodiments, the item recommendation unit 714 may select clothing products possessing a designated second attribute feature from the products possessing the corresponding attribute feature and to select clothing products from the products possessing the designated second attribute feature.

In some embodiments, the item recommendation unit 714 may sort the clothing products associated with the corresponding attribute feature according to a designated mode based on the quality scores of those products with the quality score reflecting the quality of the clothing product. The item recommendation unit 714 may then select a clothing product based on the position of which in the sequence conforms to set position conditions from the sorted clothing product sequence.

To be clear, the units included in the abovementioned device are only logical divisions based on the functions of this device. In some embodiments, these units may be layered or broken down into smaller pieces. In addition, the functions performed by the device provided by this embodiment are in a one-to-one correspondence with the clothing product recommendation method work flow provided by the embodiment mentioned above. A more detailed processing flow for this device has already been described in detail in the preceding method embodiments and will not be discussed further here.

A person skilled in the art should understand that the embodiments of this disclosure may be provided as methods, equipment (devices), or computer program products. Therefore, this disclosure may adopt the form of all-hardware embodiments, all-software embodiments, or combined software-hardware embodiments. In addition, this disclosure may employ the form of a computer program product implemented on one or more computer storage media (including but not limited to disk memory, CD-ROMs, and optical memory) containing computer programming code.

The description of this disclosure refers to flow charts and/or block diagrams based on the methods, equipment (devices), and computer program products of this disclosure's embodiments. It should be understood that computer program commands may be used to implement every process and/or box of the flow charts and/or block diagrams, as well as combinations of the processes and/or boxes of the flow charts and/or block diagrams. These computer program commands may be provided for general-purpose computers, special-purpose computers, embedded processors, or the processors of other programmable data processing devices in order to produce a machine, enabling, through commands executed by a computer or a processor of another programmable data processing device, the generation of a device used to implement the designated functions of one or more processes of a flow chart and/or one or more boxes of a block diagram.

These computer program commands may also be stored in computer-readable memory that may guide a computer or other programmable data processing device to work in a special way, enabling the commands stored in the computer-readable memory to generate a product containing a command device. This command device implements the functions designated by one or more processes in a flow chart and/or one or more boxes in a block diagram.

The computer program commands may also be loaded onto a computer or other programmable data processing device, enabling the execution of a series of operation steps on the computer or other programmable device to generate computer-implemented processing, and thus the commands executed on the computer or other programmable device provide steps used in implementing the functions designated by one or more processes in a flow chart and/or one or more boxes in a block diagram.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A method for recommending clothing items, the method comprising:
receiving, by a server, a request including a user identifier (ID) and an clothing item;
obtaining an attribute feature corresponding to the user ID based on a pre-established correspondence between the user ID and attribute features of a first attribute associated with the clothing item; and
identifying a particular clothing item based on the attribute feature.

2. The method of claim 1, wherein the pre-established correspondence is established by:
determining attribute features of the first attribute of the clothing item based on a record of clothing items that is associated with the user ID; and
establishing the pre-established correspondence between the user ID and a certain attribute feature based on a number of clothing items having the certain attribute feature.

3. The method of claim 2, wherein the number of clothing items is greater than a predetermined value.

4. The method of claim 1, wherein the pre-established correspondence is established by:
receiving multiple clothing item groups,
receiving selection associated with an individual clothing item group of the multiple clothing item groups;
determining a number of clothing items having a certain attribute feature of the first attribute; and
establishing the pre-established correspondence between the user ID and the certain attribute feature if the number is greater than a predetermined value.

5. The method of claim 4, wherein a number of clothing items in each clothing item group is the same as a number of attribute features of the first attribute of the each clothing item group, and individual attribute features of the first attribute of the each clothing item group are different from each other.

6. The method of claim 1, wherein the particular clothing item includes multiple clothing items, and the identifying a particular clothing item based on the attribute feature comprises:
selecting a certain clothing item from the multiple clothing items based on a designed attribute feature of a second attribute of the multiple clothing items.

7. The method of claim 1, wherein the particular clothing item includes multiple clothing items, and the identifying a particular clothing item based on the attribute feature comprises:
determining quality scores of the multiple clothing items;
sorting the multiple clothing items based on the quality scores to generate the sorted clothing items; and
selecting a certain clothing item from the sorted clothing items based on a predetermined rule.

8. The method of claim 1, wherein the first attribute is a style of the clothing item.

9. A system for recommending clothing items, comprising:
one or more processors; and
memory to maintain a plurality of components executable by the one or more processors, the plurality of components comprising:
an attribute value acquisition unit configured to:
receive a request including a user identifier (ID) and an clothing item, and
obtain an attribute feature corresponding to the user ID based on a pre-established correspondence between the user ID and attribute features of a first attribute associated with the clothing item, and
an item recommendation unit configured to identify a particular clothing item based on the attribute feature.

10. The system of claim 9, wherein the pre-established correspondence is established by:
determining attribute features of the first attribute of the clothing item based on a record of clothing items that is associated with the user ID; and
establishing the pre-established correspondence between the user ID and a certain attribute feature based on a number of clothing items having the certain attribute feature.

11. The system of claim 10, wherein the number of clothing items is greater than a predetermined value.

12. The system of claim 9, wherein the pre-established correspondence is established by:
receiving multiple clothing item groups,
receiving a selection associated with an individual clothing item group of the multiple clothing item groups;
determining a number of clothing items having a certain attribute feature of the first attribute; and
establishing the pre-established correspondence between the user ID and the certain attribute feature if the number is greater than a predetermined value.

13. The system of claim 12, wherein a number of clothing items in each clothing item group is the same as a number of attribute features of the first attribute of the each clothing item group, and individual attribute features of the first attribute of the each clothing item group are different from each other.

14. The system of claim 9, wherein the particular clothing item includes multiple clothing items, and the identifying a particular clothing item based on the attribute feature comprises:
selecting a certain clothing item from the multiple clothing items based on a designed attribute feature of a second attribute of the multiple clothing items.

15. The system of claim 9, wherein the particular clothing item includes multiple clothing items, and the identifying a particular clothing item based on the attribute feature comprises:
determining quality scores of the multiple clothing items;
sorting the multiple clothing items based on the quality scores to generate the sorted clothing items; and
selecting a certain clothing item from the sorted clothing items based on a predetermined rule.

16. One or more computer-readable media storing computer-executable instructions that, when executed by one or more processors, instruct the one or more processors to perform acts comprising:
receiving a request including a user identifier (ID) and an clothing item;
obtaining an attribute feature corresponding to the user ID based on a pre-established correspondence between the user ID and attribute features of a first attribute associated with the clothing item, the pre-established correspondence is established by:
determining attribute features of the first attribute of the clothing item based on a record of clothing items that is associated with the user ID, and
establishing the pre-established correspondence between the user ID and a certain attribute feature based on a number of clothing items having the certain attribute feature; and
identifying a particular clothing item based on the attribute feature.

17. The one or more computer-readable media of claim 16, wherein the number of clothing items is greater than a predetermined value.

18. The one or more computer-readable media of claim 16, wherein the particular clothing item includes multiple clothing items, and the identifying a particular clothing item based on the attribute feature comprises:
selecting a certain clothing item from the multiple clothing items based on a designed attribute feature of a second attribute of the multiple clothing items.

19. The one or more computer-readable media of claim 16, wherein the particular clothing item includes multiple clothing items, and the identifying a particular clothing item based on the attribute feature comprises:
determining quality scores of the multiple clothing items;
sorting the multiple clothing items based on the quality scores to generate the sorted clothing items; and
selecting a certain clothing item from the sorted clothing items based on a predetermined rule.

20. The one or more computer-readable media of claim 16, wherein the first attribute is a style of the clothing item.
